(19) United States
(12) Patent Application Publication
(10) Pub. No.: US 2025/0091269 A1
(43) Pub. Date: Mar. 20, 2025

(54) INJECTION MOLDING MACHINE SYSTEM, MOLD, AND MOLDING METHOD FOR MOLDED ARTICLE

(71) Applicant: THE JAPAN STEEL WORKS, LTD., Shinagawa-ku, Tokyo (JP)

(72) Inventors: Kiyotaka NAKAYAMA, Tokyo (JP); Akihiro NAITO, Tokyo (JP); Takashi UEMURA, Tokyo (JP); Keigo SUSA, Tokyo (JP); Koji MATSUZAKI, Tokyo (JP); Ryuki SAKAMOTO, Tokyo (JP); Shoso NISHIDA, Hiroshima (JP)

(21) Appl. No.: 18/726,817

(22) PCT Filed: Dec. 21, 2022
(86) PCT No.: PCT/JP2022/047250

§ 371 Date: Jul. 4, 2024

(30) Foreign Application Priority Data
Jan. 6, 2022 (JP) 2022-001282

(51) Int. Cl. B29C 45/26; B29C 45/00; B29C 45/64; B29C 45/72; B29C 45/80

(52) U.S. Cl. CPC B29C 45/2624; B29C 45/2681; B29C 45/64; B29C 45/7207; B29C 45/80; B29C 2045/0072

(57) ABSTRACT

An injection molding machine system includes an injection molding machine, a mold, heater device, and a pressing device. The mold includes a fixed side mold and a slide mold. When the slide mold is clamped at a first mold clamping position, one primary molding cavity is formed by a slide side recessed portion, and one primary molding cavity is formed by a fixed side recessed portion. A pair of primary molded articles, are molded by injection molding. The mold is opened, and bonding end surfaces of the primary molded article remaining in the slide side recessed portion and the primary molded article remaining in the fixed side recessed portion are melted by the heating device. When the slide mold is clamped at a second mold clamping position, a secondary molding cavity is formed by the slide side recessed portion and the fixed side recessed portion. When the pressing device is driven, the primary molded article in the slide side recessed portion is pressed against the primary molded article in the fixed side recessed portion and the bonding end surfaces are fused together. In other words, a molded article is obtained.

### TECHNICAL FIELD

The present invention relates to an injection molding machine system in which two or more primary molded articles are molded by injection molding, the primary molded articles are paired, and bonding end surfaces of the primary molded articles are melted and fused to mold a molded article, a mold, and a molding method for a molded article.

### BACKGROUND ART

A pair of primary molded articles each having a bonding end surface are molded by injection molding. Then, the bonding end surfaces of the pair of primary molded articles are melted, and the bonding end surfaces are fused together to obtain one molded article. Patent Literature 1 describes an injection molding machine system that implements such a manufacturing method for a molded article.

### CITATION LIST

### Patent Literature

### Patent Literature 1: JP2019-155775A

The injection molding machine system described in Patent Literature 1 includes a so-called opposed double-head injection molding machine and a heater implemented by a halogen heater or a carbon heater. The opposed double-head injection molding machine includes a mold clamping device and two injection devices. The mold clamping device includes a fixed platen that is fixed to a bed, a movable platen that slides along the bed, and an intermediate platen that is rotatably provided between the fixed platen and the movable platen and slides along the bed. The fixed platen, the intermediate platen, and the movable platen are each provided with a mold. When the molds are clamped, the mold of the fixed platen and the mold of the intermediate platen are clamped, and the mold of the intermediate platen and the mold of the movable platen are clamped. That is, when the plurality of molds are clamped, cavities are formed at parting lines on two sides. When resin is injected from injection devices provided on the fixed platen and the movable platen, respectively, one primary molded article is molded between the fixed platen and the intermediate platen, and one primary molded article is molded between the movable platen and the intermediate platen.

The molds are opened. Thus, the molds are opened with one primary molded article remaining in the mold of the fixed platen and the other primary molded article remaining in the mold of the intermediate platen. The intermediate platen is rotated. That is, the intermediate platen is reversed. Thus, the two primary molded articles face each other. An amount of mold opening between the fixed platen and the intermediate platen is made small, and a heater is inserted between the two primary molded articles in a non-contact manner to heat the primary molded articles. The two primary molded articles each have a bonding end surface formed thereon, and these bonding end surfaces are melted. The heater is retracted, and the fixed platen and the intermediate platen are clamped. In this way, the two primary molded articles are fused together at the bonding end surfaces to obtain a molded article.

### SUMMARY OF INVENTION

### Technical Problem

The injection molding machine system described in Patent Literature 1 is excellent in molding a molded article efficiently. However, in order to reliably fuse two primary molded articles together by clamping the molds, high dimensional accuracy is required for the primary molded articles. This is because if the dimensions of the two primary molded articles are smaller than an allowable range, fusion will be insufficient even though the molds are clamped. Further, in a case where the dimensions of the two primary molded articles are larger than the allowable range, when the molds are mold clamped after the bonding end surfaces of the two primary molded articles are melted, there is a possibility that a part of the molten resin may leak to a parting line of the mold and damages the mold.

In view of the above problems, it is an object of the present disclosure to provide an injection molding machine system, a mold, and a molding method for a molded article that can reliably fuse a pair of primary molded articles together when molding a molded article, while minimizing a risk of damaging a mold.

Other problems and novel features will become apparent from description of the present description and the accompanying drawings.

### Solution to Problem

The present inventors have found that the above problem can be solved by configuring an injection molding machine system as follows. That is, the present disclosure relates to an injection molding machine system including an injection molding machine, a mold, heating means, and pressing means. The mold is configured such that one mold half is slid relative to the other mold half and is configured to clamp at two or more mold clamping positions including a first mold clamping position and a second mold clamping position. The one mold half is provided with at least one one-side recessed portion in which the pressing means is provided, and the other mold half is provided with at least one other-side recessed portion. When the mold is clamped in the first mold clamping position, at least one primary molding cavity is formed by the one-side recessed portion, at least one primary molding cavity is formed by the other-side recessed portion, and two or more primary molded articles are molded by injection molding. The heating means is configured to melt the bonding end surface of the primary molded article placed in the one-side recessed portion and the bonding end surface of the primary molded article placed in the other-side recessed portion in a state where the mold is opened. When the mold is clamped in the second mold clamping position, a secondary molding cavity is formed by the one-side recessed portion and the other-side recessed portion. The pair of primary molded articles, which are placed in the secondary molding cavity and have the bonding end surfaces melted, are pressed by the pressing means to be fused together, thereby obtaining a molded article.

### Advantageous Effects of Invention

It is possible to provide an injection molding machine system in which an allowable range for dimensions of a primary molded article and a mold is increased, a pair of primary molded articles can be reliably fused to obtain a molded article, while minimizing the risk of damaging the mold.

### BRIEF DESCRIPTION OF DRAWINGS

FIG. 1 is a top view showing an injection molding machine system according to a first embodiment.

FIG. 2A is a front cross-sectional view showing a part of an injection molding machine, a mold, and pressing means according to the first embodiment.

FIG. 2B is a top cross-sectional view showing a part of the injection molding machine, the mold, and the pressing means according to the first embodiment, taken along a line X-X in FIG. 2A.

FIG. 3A is a front cross-sectional view showing a part of the injection molding machine and the mold, which are performing a molding method for a molded article according to the first embodiment.

FIG. 3B is a front cross-sectional view showing a part of the injection molding machine and the mold, which are performing the molding method for a molded article according to the first embodiment.

FIG. 3C is a front cross-sectional view showing a part of the injection molding machine and the mold, which are performing the molding method for a molded article according to the first embodiment.

FIG. 3D is a top cross-sectional view showing a part of the injection molding machine, the mold, and the pressing means, which are performing the molding method for a molded article according to the first embodiment, taken along the line X-X in FIG. 2A.

FIG. 3E is a top cross-sectional view showing a part of the injection molding machine, the mold, and the pressing means, which are performing the molding method for a molded article according to the first embodiment, taken along the line X-X in FIG. 2A.

FIG. 3F is a top cross-sectional view showing a part of the injection molding machine, the mold, and the pressing means, which are performing the molding method for a molded article according to the first embodiment, taken along the line X-X in FIG. 2A.

FIG. 4 is a flowchart showing the molding method for a molded article according to the first embodiment.

FIG. 5A is a front cross-sectional view showing a part of an injection molding machine, a mold, and pressing means according to a second embodiment.

FIG. 5B is a top cross-sectional view showing a part of the injection molding machine, the mold, and the pressing means according to the second embodiment, taken along a line Y-Y in FIG. 5A.

FIG. 6A is a front cross-sectional view showing a part of the injection molding machine, the mold, and the pressing means, which are performing a molding method for a molded article according to the second embodiment.

FIG. 6B is a front cross-sectional view showing a part of the injection molding machine, the mold, and the pressing means, which are performing the molding method for a molded article according to the second embodiment.

FIG. 6C is a front cross-sectional view showing a part of the injection molding machine, the mold, and the pressing means, which are performing the molding method for a molded article according to the second embodiment.

FIG. 6D is a top cross-sectional view showing a part of the injection molding machine, the mold, and the pressing means, which are performing the molding method for a molded article according to the second embodiment, taken along a line Y′-Y′ in FIG. 6C.

FIG. 6E is a front cross-sectional view showing a part of the injection molding machine, the mold, and the pressing means, which are performing the molding method for a molded article according to the second embodiment.

FIG. 6F is a top cross-sectional view showing a part of the injection molding machine, the mold, and the pressing means, which are performing the molding method for a molded article according to the second embodiment, taken along the line Y′-Y′ in FIG. 6C.

FIG. 7A is a back view showing a fixed side mold provided in an injection molding machine according to a third embodiment.

FIG. 7B is a front view showing a rotary mold provided in the injection molding machine according to the third embodiment.

FIG. 7C is a front view showing the rotary mold provided in the injection molding machine according to the third embodiment.

FIG. 8 is a top view showing an injection molding machine system according to a fourth embodiment.

FIG. 9 is a front cross-sectional view showing a part of an injection molding machine and a mold according to the fourth embodiment.

FIG. 10 is a top view showing an injection molding machine system according to a fifth embodiment.

FIG. 11 is a front cross-sectional view showing a part of an injection molding machine and a mold according to the fifth embodiment.

FIG. 12A is a front cross-sectional view showing a part of an injection molding machine, a mold, and pressing means according to a sixth embodiment.

FIG. 12B is a front cross-sectional view showing a part of the injection molding machine, the mold, and the pressing means according to the sixth embodiment.

FIG. 13A is a top cross-sectional view showing a part of an injection molding machine, a mold, and pressing means according to a seventh embodiment.

FIG. 13B is a top cross-sectional view showing a part of the injection molding machine, the mold, and the pressing means according to the seventh embodiment.

### DESCRIPTION OF EMBODIMENTS

Hereinafter, specific embodiments will be described in detail with reference to the drawings. The present disclosure is not limited to the following embodiments. In order to clarify the description, the following description and the drawings are simplified as appropriate. In the drawings, the same elements are denoted by the same reference numerals, and repeated description thereof is omitted as necessary. In addition, hatching may be omitted to avoid complicating the drawings.

An injection molding machine system according to the present embodiment includes: an injection molding machine; a mold provided in the injection molding machine; heating means; and pressing means, in which
the mold is configured such that one mold half is slidable relative to the other mold half and is configured to clamp at two or more mold clamping positions including a first mold clamping position and a second mold clamping position,
the one mold half has at least one one-side recessed portion in which the pressing means is provided, and the other mold half has at least one other-side recessed portion,
when the mold is clamped in the first mold clamping position, at least one primary molding cavity is formed by the one-side recessed portion, and at least one primary molding cavity is formed by the other-side recessed portion,
when the mold is closed or clamped in the second mold clamping position, a secondary molding cavity is formed by the one-side recessed portion and the other-side recessed portion,
the primary molding cavity is configured to mold a primary molded article having a bonding end surface by injection molding,
the heating means is configured to melt the bonding end surface of the primary molded article placed in the one-side recessed portion and the bonding end surface of the primary molded article placed in the other-side recessed portion, and
the pressing means is configured to press, in the secondary molding cavity, the primary molded article having the molten bonding end surface and placed in the one-side recessed portion to fuse with the primary molded article having the molten bonding end surface and placed in the other-side recessed portion.

A mold according to the present embodiment, in which
one mold half is slidable relative to the other mold half such that the mold is clamped at two or more mold clamping positions including a first mold clamping position and a second mold clamping position,
the one mold half has at least one one-side recessed portion in which pressing means is provided, and the other mold half has at least one other-side recessed portion,
when the one mold half and the other mold half are clamped in the first mold clamping position, at least one primary molding cavity is formed by the one-side recessed portion, and at least one primary molding cavity is formed by the other-side recessed portion,
when the one mold half and the other mold half are clamped in the second mold clamping position, a secondary molding cavity is formed by the one-side recessed portion and the other-side recessed portion,
the primary molding cavity is for molding a primary molded article having a bonding end surface by injection molding, and
the pressing means is configured to press, in the secondary molding cavity, the primary molded article placed in the one-side recessed portion against the primary molded article placed in the other-side recessed portion.

A molding method for a molded article according to the present embodiment is a molding method for molding a molded article in an injection molding machine system,
the injection molding machine system including an injection molding machine, a mold provided in the injection molding machine, heating means, and pressing means,
the mold being configured such that one mold half is slidable relative to the other mold half and is configured to clamp at two or more mold clamping positions including a first mold clamping position and a second mold clamping position,
the one mold half having at least one one-side recessed portion in which the pressing means is provided, and the other mold half having at least one other-side recessed portion,
when the mold is clamped in the first mold clamping position, at least one primary molding cavity being formed by the one-side recessed portion, and at least one primary molding cavity being formed by the other-side recessed portion, and
when the mold is clamped in the second mold clamping position, a secondary molding cavity being formed by the one-side recessed portion and the other-side recessed portion,
the molding method including:
an injection molding step including molding two or more primary molded articles each having a bonding end surface by clamping the mold in the first mold clamping position and injecting resin into the two or more primary molding cavities;
a mold opening step including opening the mold, leaving at least one of the primary molded articles in the one-side recessed portion and one of the primary molded articles in the other-side recessed portion;
a melting step including melting the bonding end surfaces of the two or more primary molded articles by the heating means;
a mold closing step including retracting the heating means, and closing or clamping the mold at the second mold clamping position to align the one primary molded article placed in the one-side recessed portion and the primary molded article placed in the other-side recessed portion in the secondary molding cavity; and
a press-fusion step including pressing the primary molded article placed in the one-side recessed portion against the primary molded article placed in the other-side recessed portion by the pressing means to fuse the bonding end surfaces of the primary molded articles together, resulting in the molded article.

### First Embodiment

### <Injection Molding Machine System>

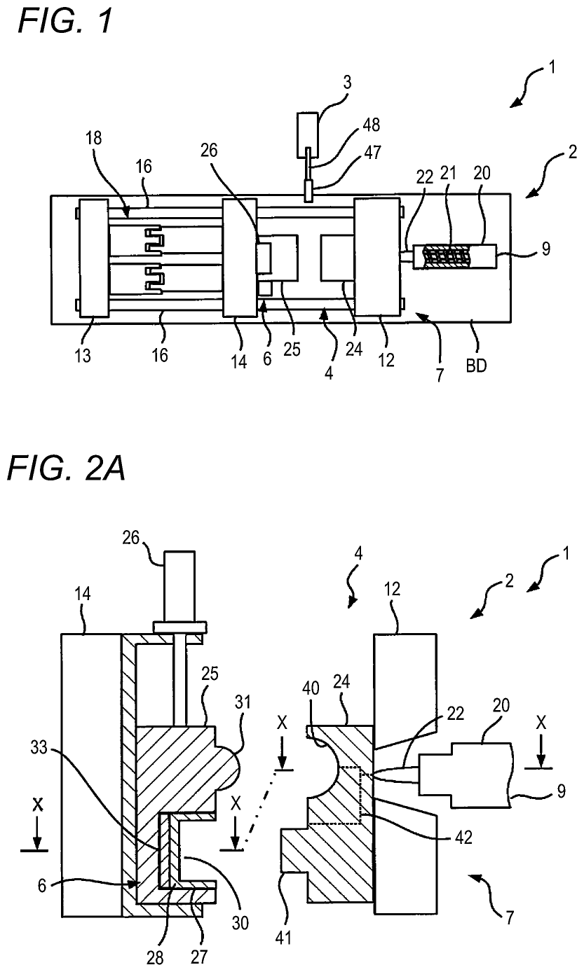

As shown in FIG. 1, an injection molding machine system 1 according to a first embodiment includes an injection molding machine 2, a heater device 3 serving as heating means provided adjacent to the injection molding machine 2, and a mold 4 provided in the injection molding machine 2. As will be described in detail later, the mold 4 is configured such that one mold half is slidable relative to the other mold half to switch a mold clamping position. The mold 4 is provided with pressing means 6 which is a characteristic mechanism in the present embodiment.

### <Injection Molding Machine>

The injection molding machine 2 according to the first embodiment includes a mold clamping device 7 and an injection device 9 provided on a bed BD.

### <Mold Clamping Device>

The mold clamping device 7 includes a fixed platen 12 fixed on the bed BD, a mold clamping housing 13 slidably provided on the bed BD, and a movable platen 14 slidably provided on the bed BD between the fixed platen 12 and the mold clamping housing 13. The fixed platen 12 and the mold clamping housing 13 are coupled by a plurality of tie bars 16, 16, . . . , and the tie bars 16, 16, . . . penetrate the movable platen 14. A toggle mechanism 18 serving as a mold clamping mechanism is provided between the mold clamping housing 13 and the movable platen 14. Accordingly, when the toggle mechanism 18 is driven, the movable platen 14 is driven. Note that another mechanism such as a mold clamping cylinder may be adopted as the mold clamping mechanism.

### <Injection Device>

The injection device 9 includes a heating cylinder 20 and a screw 21 placed in the heating cylinder 20. An injection nozzle 22 is provided at a tip end of the heating cylinder 20, and to come into contact with the mold 4 to be described in detail below with a predetermined touch force.

### <Mold>

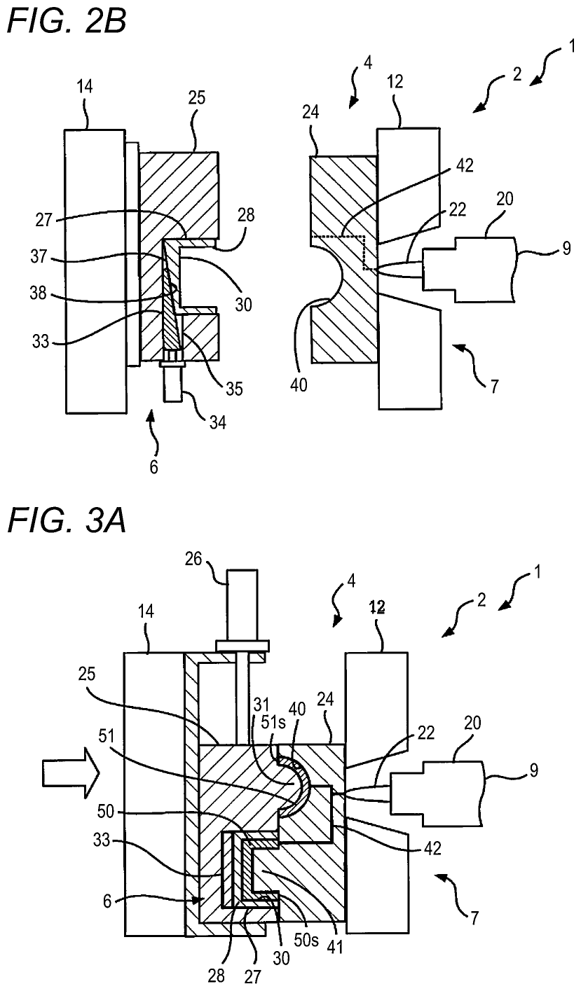

As shown in FIG. 2A, the mold 4 according to the first embodiment includes a fixed side mold 24 provided on the fixed platen 12 and a slide mold 25 provided on the movable platen 14. The slide mold 25 is provided with a cylinder unit 26, that is, driving means, so as to slide linearly. In other words, the slide mold 25, that is, one mold half, is slid relative to the fixed side mold 24, that is, the other mold half. Thus, as described later, the mold 4 is clamped at each of a first mold clamping position and a second mold clamping position.

In this manner, the one mold half may be linearly slid with respect to the other mold half, and the mold may be clamped at two or more mold clamping positions including the first and second mold clamping positions, depending on a sliding position.

### <Slide Mold>

The slide mold 25 has a core storage hole 27, a slide core 28 is stored in the core storage hole 27. The slide core 28 slides in a direction perpendicular to a parting line of the slide mold 25 by the pressing means 6 described below. A slide side recessed portion 30 is formed in the slide core 28. The slide mold 25 is formed with a slide side protruding portion 31 at a position separated from the slide core 28. Accordingly, the slide side recessed portion 30 and the slide side protruding portion 31 are the recessed portion and the protruding portion for forming different primary molding cavities, as described later. The slide side recessed portion 30 is formed in the slide mold 25, that is, the one mold half, and is therefore referred to as one-side recessed portion in this description.

As described above, it is preferable that the one-side recessed portion is formed in the slide core stored in the core storage hole opened in the one mold half, and the slide core is driven by the pressing means in the direction perpendicular to the parting line of the mold.

### <Pressing Means>

The pressing means 6 will be described with reference to FIG. 2B, which is a top cross-sectional view of the mold 4 taken along a line X-X in FIG. 2A. The pressing means 6 includes a slide member 33, a hydraulic cylinder 34 for driving the slide member 33, and the slide core 28. That is, the slide core 28 makes up the slide mold 25 and also makes up the pressing means 6. The slide member 33 is inserted into the core storage hole 27 from a hole 35 opened from a side of the slide mold 25, and is slidable along a bottom surface of the core storage hole 27. An inclined tapered surface 37 is formed on a back surface of the slide core 28. Also, an inclined tapered surface 38 is formed on a front surface of the slide member 33. The tapered surfaces 37 and 38 are in smooth contact with each other. Accordingly, when the slide member 33 is driven by the hydraulic cylinder 34, the slide core 28 is driven in the direction perpendicular to the parting line.

As described above, it is preferable that the pressing means includes a slide member that slides parallel to the parting line of the mold, the back surface of the slide core and the front surface of the slide member are respectively formed into tapered surfaces, and the tapered surfaces allow for sliding contact with each other.

### <Fixed Side Mold>

As shown in FIG. 2A, the fixed side mold 24 is formed with a fixed side recessed portion 40 and a fixed side protruding portion 41. As will be described later, when the slide mold 25 is set to a first mold clamping position and the mold 4 is clamped, the slide side recessed portion 30 and the fixed side protruding portion 41 form one primary molding cavity, and the fixed side recessed portion 40 and the slide side protruding portion 31 form one primary molding cavity. The fixed side recessed portion 40 is formed in the fixed side mold 24, that is, the other mold half, and is therefore referred to as an other-side recessed portion in this description. The fixed side mold 24 includes a runner 42 through which resin injected from the injection device 9 flows.

### <Heater Device>

As shown in FIG. 1, the heater device 3 according to the first embodiment is provided in the vicinity of the fixed platen 12. The heater device 3 includes a heater 47 and a drive unit 48 that is configured to drive the heater 47 to slide back and forth. The heater 47 is a carbon heater or a halogen heater. The heater 47 is supplied with an electric current from a power supply unit (not shown), and reaches a temperature of 1000° C. or higher within a few seconds after being energized. Accordingly, resin in the vicinity can be melted in a short time in a non-contact manner. That is, the heater device 3 according to the present embodiment is not only a simple heating means but also a non-contact heating means. As described above, it is preferable that the heating means includes a heater which emits infrared rays to melt the bonding end surfaces in a non-contact manner.

### <Molding Method for Molded Article>

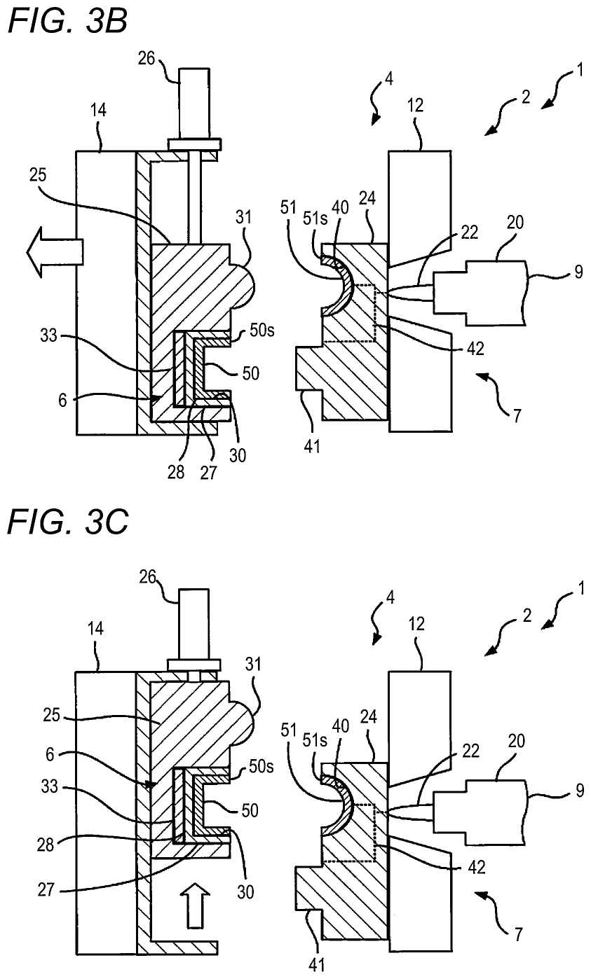

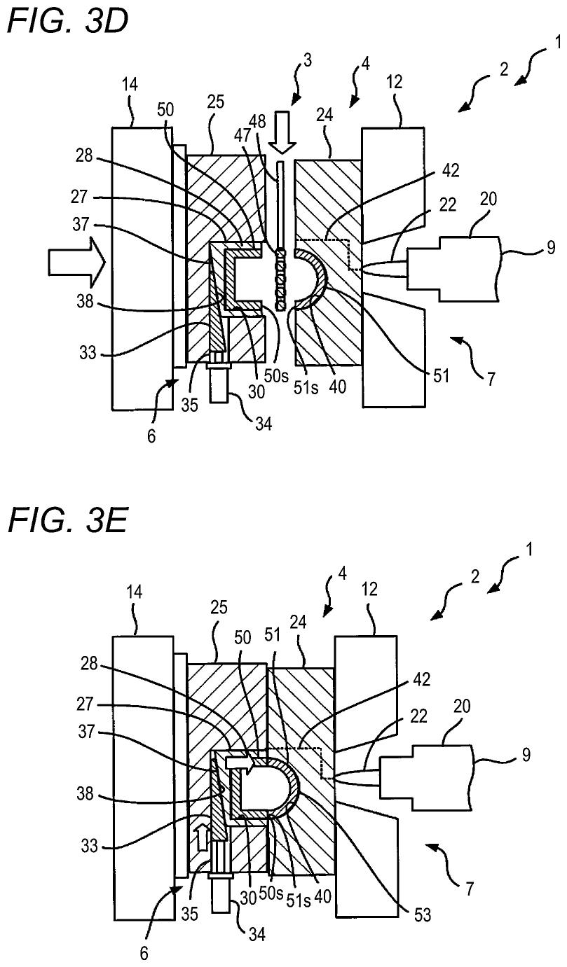

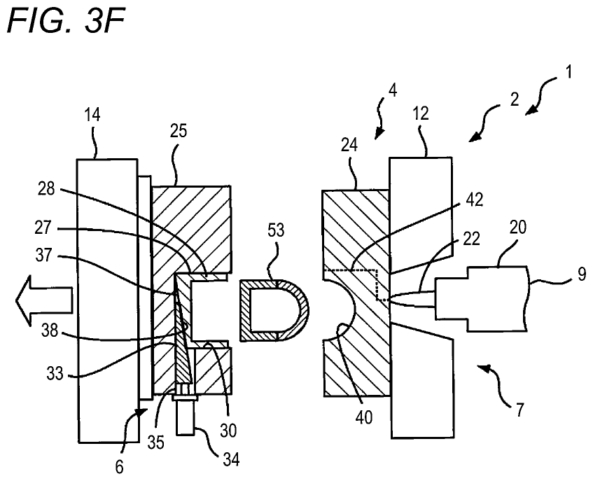

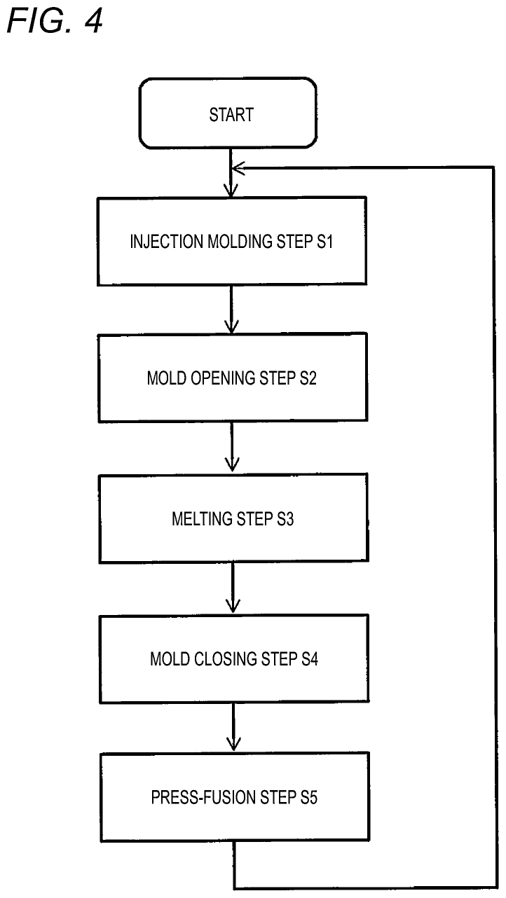

A molding method for molding a molded article using the injection molding machine system 1 (see FIGS. 1, 2A, and 2B) will be described. First, as shown in FIG. 4, an injection molding step S1 is performed. As shown in FIG. 3A, the cylinder unit 26 is driven to move the slide mold 25 to the first mold clamping position. Next, the mold clamping device 7 is driven to clamp the mold 4. When the mold is clamped, the slide side recessed portion 30 and the fixed side protruding portion 41 form one primary molding cavity, and the fixed side recessed portion 40 and the slide side protruding portion 31 form one primary molding cavity. Resin is injected from the injection device 9 to fill the primary molding cavities, and a first primary molded article 50 and a second primary molded article 51, that is, a pair of primary molded articles 50 and 51 are molded.

After the pair of primary molded articles 50 and 51 are cooled and solidified, a mold opening step S2 is performed as shown in FIG. 4. That is, the mold clamping device 7 is driven to open the mold 4. As shown in FIG. 3B, the first primary molded article 50 is left in the slide side recessed portion 30, that is, the one-side recessed portion, and the second primary molded article 51 is left in the fixed side recessed portion 40, that is, the other-side recessed portion. The first and second primary molded articles 50 and 51 have bonding end surfaces 50s and 51s, respectively.

Then, as shown in FIG. 4, a melting step S3 is performed. First, as shown in FIG. 3C, the cylinder unit 26 is driven to slide the slide mold 25 to the second mold clamping position. Thus, the first primary molded article 50 and the second primary molded article 51 face each other. That is, the bonding end surfaces 50s and 51s face each other.

The mold clamping device 7 is driven to bring the bonding end surfaces 50s and 51s of the pair of primary molded articles 50 and 51 close to each other as shown in FIG. 3D. The heater device 3 is driven to insert the heater 47 between the bonding end surfaces 50s and 51s in a non-contact manner. The heater 47 is energized to melt the bonding end surfaces 50s and 51s in a non-contact manner. Alternatively, the heater device 3 may be first driven to be positioned between the bonding end surfaces 50s and 51s, and then the mold clamping device 7 may be driven to bring the bonding end surfaces 50s and 51s close to the heater 47. When the bonding end surfaces 50s and 51s are melted by the heater 47, the drive unit 48 is driven to retract the heater 47.

As shown in FIG. 4, a mold closing step S4 is performed. The mold is closed or clamped in a state where the slide mold 25 is in the second mold clamping position. Then, as shown in FIG. 3E, the slide side recessed portion 30 of the slide mold 25, that is, the one-side recessed portion, and the fixed side recessed portion 40 of the fixed side mold 24, that is, the other-side recessed portion form a secondary molding cavity. At this time, the pair of primary molded articles 50 and 51 are in a state where the respective bonding end surfaces 50s and 51s are slightly spaced apart from each other in the secondary molding cavity. Since the bonding end surfaces 50s and 51s are spaced apart from each other, the resin is not pushed out laterally from the molten bonding end surfaces 50s and 51s and does not leak out to the parting line.

As shown in FIG. 4, a press-fusion step S5 is performed. As shown in FIG. 3E, the pressing means 6 is driven. That is, the hydraulic cylinder 34 is driven to push the slide member 33 into the core storage hole 27. Then, the slide core 28 is driven in the direction of the parting line by the action of the tapered surfaces 37 and 38. Accordingly, the pair of primary molded articles 50 and 51 are pressed against each other, and the bonding end surfaces 50s and 51s are fused together. A molded article 53 is molded. By being pressed by the pressing means 6, the pair of primary molded articles 50 and 51 can be reliably fused together. That is, the dimensional accuracy required for the primary molded articles 50 and 51 is relatively relaxed, and the primary molded articles 50 and 51 can be molded stably.

When the mold clamping device 7 is driven to open the mold 4, the molded article 53 is obtained as shown in FIG. 3F. At this time, the hydraulic cylinder 34 of the pressing means 6 is driven to slide the slide member 33 to an original position. Although not shown, the slide core 28 is provided with, for example, a spring or the like, and is biased toward the back of the core storage hole 27. When the slide member 33 slides to the original position, the slide core 28 slides to the back of the core storage hole 27. That is, it prepares for the next molding cycle. Thereafter, the molding cycle is repeated in the same manner.

The injection molding machine system includes a control unit, in which the control unit is configured to perform:
an injection molding step including sliding the one mold half relatively to the other mold half to clamp the mold at the first mold clamping position and injecting into the primary molding cavities to form two or more primary molded articles;
a melting step including opening the mold and melting the bonding end surface of the primary molded article remaining in the one-side recessed portion and the bonding end surface of the primary molded article remaining in the other-side recessed portion by the heating means;
a mold closing step including sliding the one mold half relative to the other mold half, and closing or clamping the mold at the second mold clamping position to form the secondary molding cavity; and
a press-fusion step including pressing a pair of the primary molded articles placed in the secondary molding cavity by the pressing means to fuse the bonding end surfaces together, resulting in a molded article.

### Second Embodiment

### <Injection Molding Machine System>

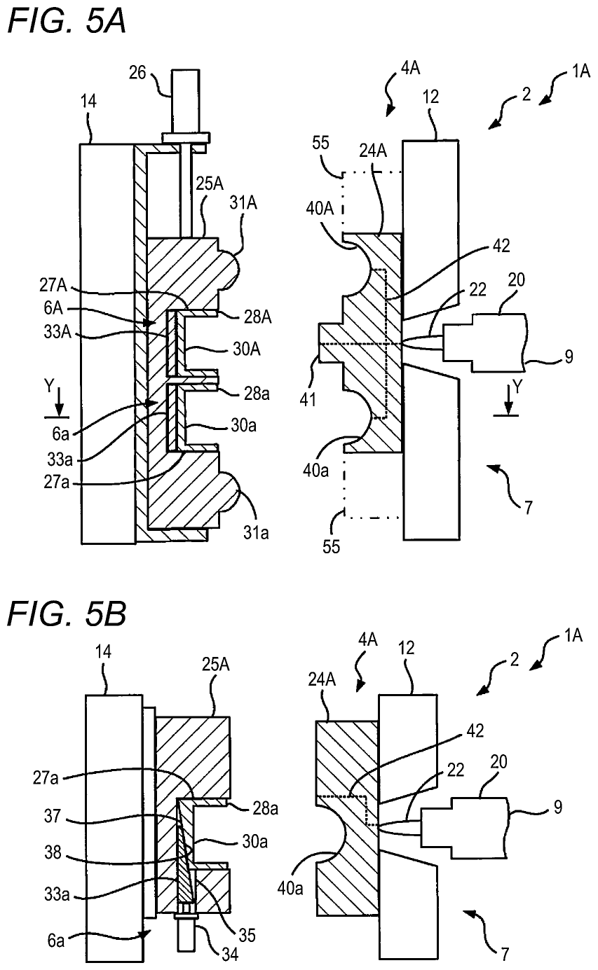

The configuration of an injection molding machine system 1A according to a second embodiment is substantially the same as that of the injection molding machine system according to the first embodiment, but the mold 4 is different. A mold 4A according to the second embodiment will be described with reference to FIG. 5A.

### <Mold>

As shown in FIG. 5A, the mold 4A according to the second embodiment also includes a fixed side mold 24A and a slide mold 25A. Components having the same functions as those of the mold 4 (see FIGS. 2 and 3) according to the first embodiment will be described by reference numerals that combine the same numbers and letters. In the mold 4A according to the second embodiment, a first core storage hole 27A and a second core storage hole 27a are formed in the slide mold 25A, and a first slide core 28A and a second slide core 28a are respectively inserted in the first core storage hole 27A and the second core storage hole 27a. The first slide core 28A and the second slide core 28a are formed with a first slide side recessed portion 30A and a second slide side recessed portion 30a, respectively. A first slide side protruding portion 31A and a second slide side protruding portion 31a are formed on outer sides of the first slide core 28A and the second slide core 28a, respectively. Further, the fixed side mold 24A is formed with one fixed side protruding portion 41 and first and second fixed side recessed portions 40A and 40a on both sides thereof.

FIG. 5B is a top cross-sectional view of the mold 4A taken along a line Y-Y in FIG. 5A. Although FIG. 5B shows only the second slide core 28a of the first and second slide cores 28A and 28a, the slide mold 25A is provided with pressing means 6A and 6a corresponding to the first and second slide cores 28A and 28a, respectively, so that the first and second slide cores 28A and 28a slide independently.

As described below, the mold 4A according to the second embodiment is also clamped at two different mold clamping positions. Regardless of the mold clamping position at which the mold is clamped, one of the first and second slide side protruding portions 31A and 31a formed on the slide mold 25A protrudes to the side of the fixed side mold 24A. Therefore, spaces 55, 55 are secured on both sides of the fixed side mold 24A so as not to interfere with the first and second slide side protruding portions 31A and 31a.

### <Molding Method for Molded Article>

Using the injection molding machine system according to the second embodiment, a molding method which is a modification of the molding method according to the first embodiment can be performed to efficiently mold a molded article. This will be described.

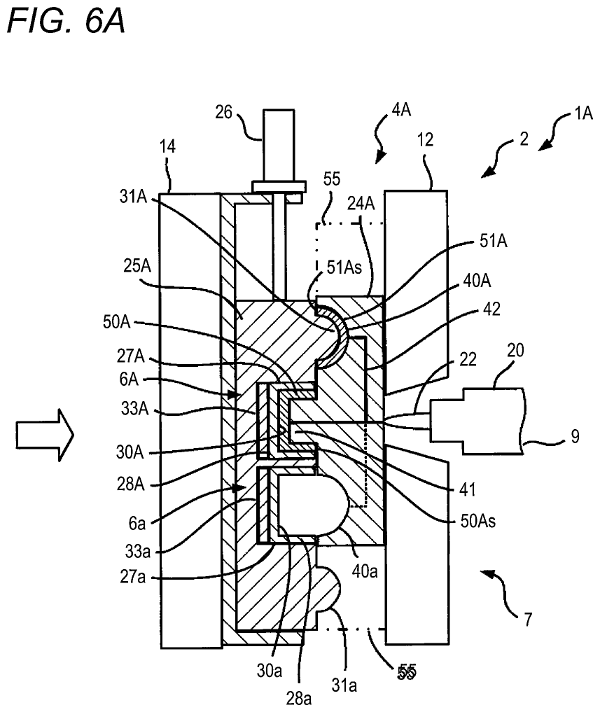

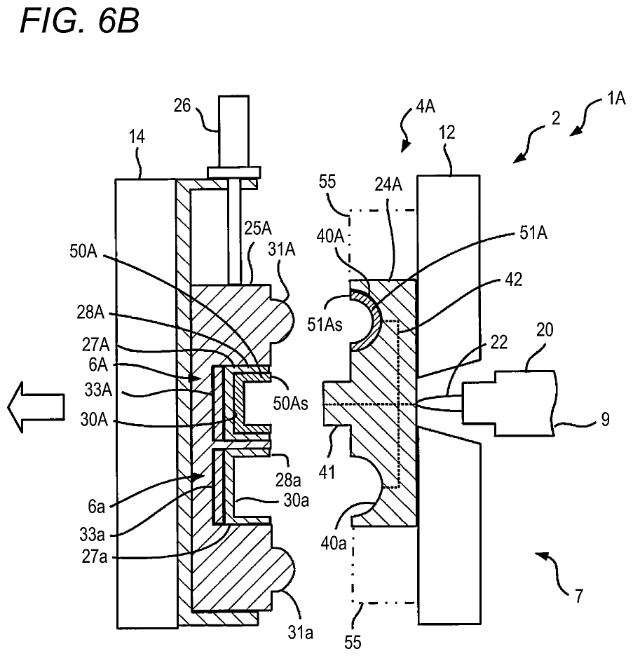

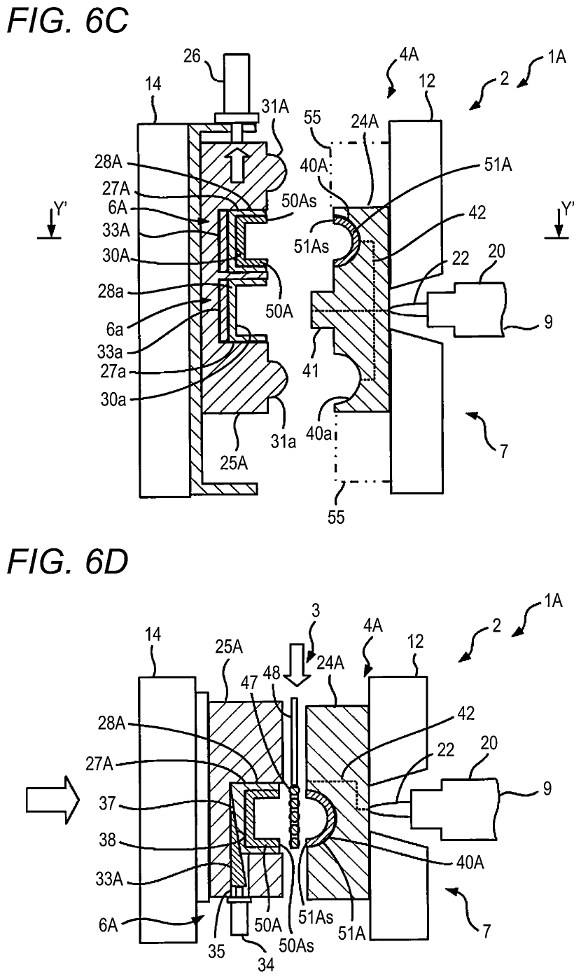

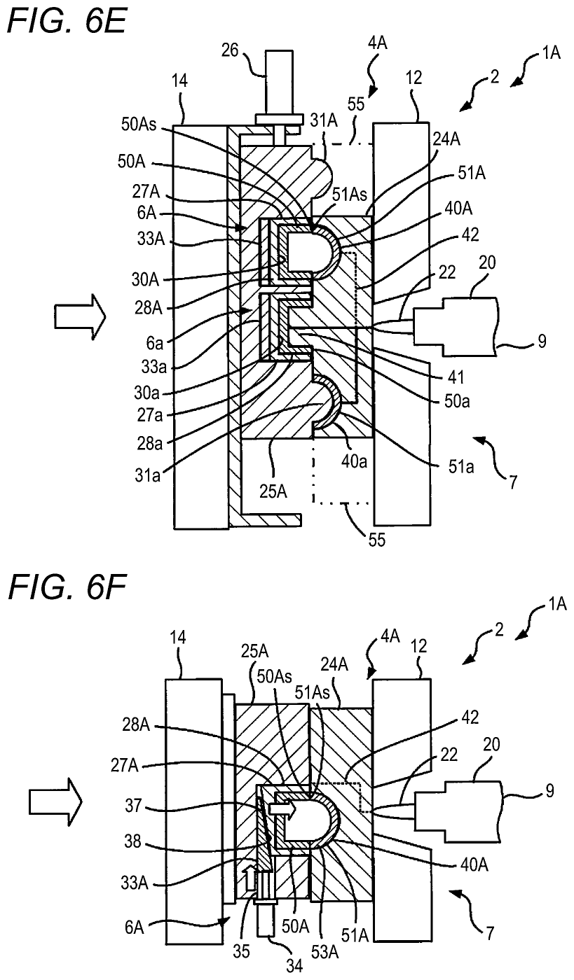

As shown in FIG. 6A, the mold 4A is clamped. Then, the first slide side recessed portion 30A and the fixed side protruding portion 41 form one primary molding cavity, and the first slide side protruding portion 31A and the first fixed side recessed portion 40A form one primary molding cavity. That is, regarding the first slide side recessed portion 30A, the fixed side protruding portion 41, the first slide side protruding portion 31A, and the first fixed side recessed portion 40A, since the primary molding cavity is formed therein, the mold is clamped at the first mold clamping position. Resin is injected from the injection device 9 to mold first and second primary molded articles 50A and 51A. That is, the injection molding step S1 (see FIG. 4) is performed. In the mold 4A according to the second embodiment, a valve gate is adopted, and a cavity into which the resin is injected can be selected.

As shown in FIG. 6B, the mold 4A is opened. That is, the mold opening step S2 (see FIG. 4) is performed. Thus, the mold is opened with the first primary molded article 50A remaining in the first slide side recessed portion 30A, that is, the one-side recessed portion, and the second primary molded article 51A remaining in the first fixed side recessed portion 40A, that is, the other-side recessed portion. The cylinder unit 26 is driven to slide the slide mold 25A. Thus, as shown in FIG. 6C, the first primary molded article 50A and the second primary molded article 51A face each other at respective bonding end surfaces 50As and 51As.

Next, the melting step S3 (see FIG. 4) is performed. As shown in FIG. 6D, the mold clamping device 7 is driven to bring the bonding end surfaces 50As and 51As of the first and second primary molded articles 50A and 51A close to each other. The heater device 3 is driven to melt the bonding end surfaces 50As and 51As by the heater 47. When the bonding end surfaces 50As and 51As are melted, the drive unit 48 is driven to retract the heater 47.

The mold closing step S4 (see FIG. 4) is performed. As shown in FIG. 6E, the mold clamping device 7 is driven to clamp the mold 4A. Thus, the first slide side recessed portion 30A and the first fixed side recessed portion 40A form a secondary molding cavity. That is, regarding the first slide side recessed portion 30A and the first fixed side recessed portion 40A, since the secondary molding cavity is formed therein, the mold is clamped at a second mold clamping position. In the secondary molding cavity, the first primary molded article 50A and the second primary molded articles and 51A face each other in a state where the bonding end surface 50As and the bonding end surface 51As are slightly spaced apart from each other.

The press-fusion step S5 (see FIG. 4) is performed. That is, as shown in FIG. 6F, the pressing means 6A is driven. That is, the first slide member 33A is slid by the hydraulic cylinder 34. Thus, the first slide core 28A slides, and the first primary molded article 50A and the second primary molded article 51A are pressed against each other. The bonding end surfaces 50As and 51As are fused together to obtain a molded article 53A.

When the mold closing step S4 (see FIG. 4) is performed to clamp the mold 4A, as shown in FIG. 6E, the second slide side recessed portion 30a and the fixed side protruding portion 41 form one primary molding cavity, and the second slide side protruding portion 31a and the second fixed side recessed portion 40a form one primary molding cavity. That is, regarding the second slide side recessed portion 30a, the fixed side protruding portion 41, the second slide side protruding portion 31a, and the second fixed side recessed portion 40a, since the primary molding cavities are formed therein, the mold is clamped at the first mold clamping position. Resin is injected from the injection device 9 to mold first and second primary molded articles 50a and 51a. In this way, the injection molding step S1 can be performed in parallel with the press-fusion step S5.

When the mold 4A is opened, the molded article 53A is obtained, and the first and second primary molded articles 50a and 51a remain in the second slide side recessed portion 30a and the second fixed side recessed portion 40a, respectively. Thereafter, molding is performed in the same manner. As described above, in the molding method according to the second embodiment, since the injection molding step S1 and the press-fusion step S5 can be performed substantially simultaneously, molding can be efficiently performed.

As described above, a control unit included in the injection molding machine system may perform the press-fusion step and the injection molding step in parallel and substantially simultaneously. Therefore, when a molded article is obtained from a pair of primary molded articles in the press-fusion step, another pair of primary molded articles may be molded in the injection molding step.

### Third Embodiment

### <Injection Molding Machine System>

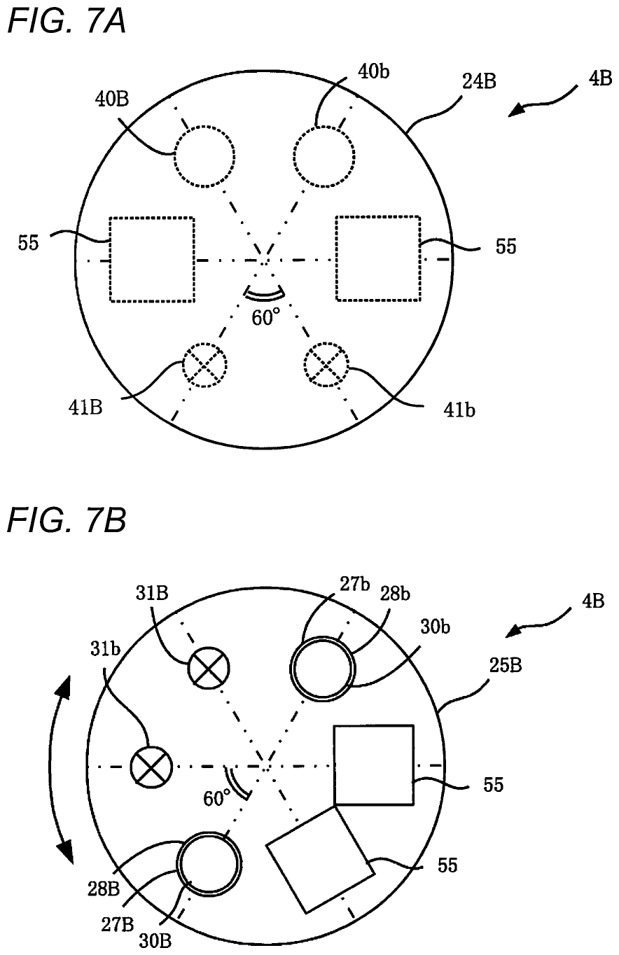

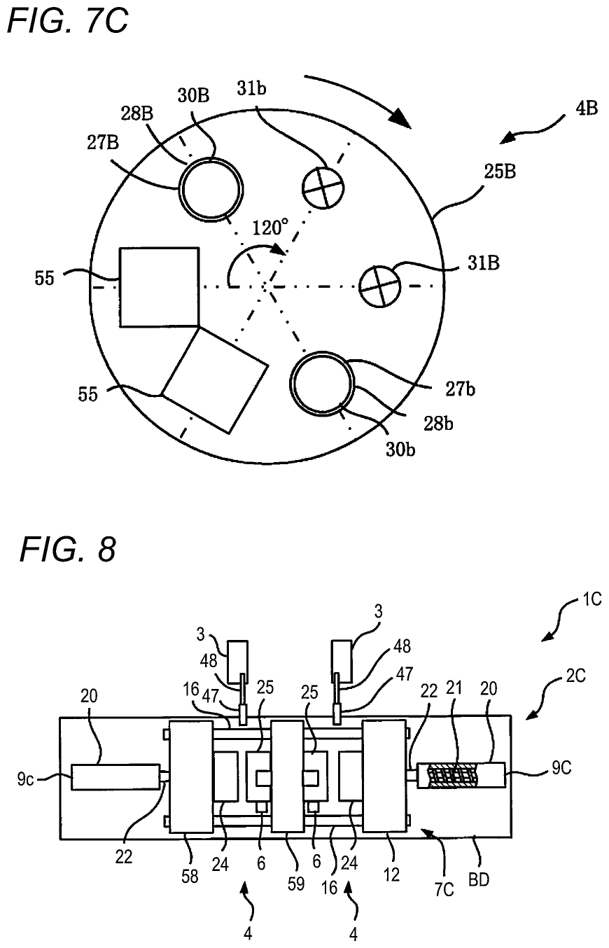

The configuration of an injection molding machine system according to a third embodiment is similar to that of the injection molding machine system according to the second embodiment, in which the injection molding step S1 and the press-fusion step S5 are performed substantially simultaneously, so that a molded article can be efficiently molded. In the injection molding machine system according to the third embodiment, a mold is used in which one mold half slides rotationally relatively to the other mold half. A mold 4B according to the third embodiment will be described with reference to FIGS. 7A and 7B. Components having the same functions as those of the mold 4 (see FIGS. 2 and 3) according to the first embodiment and the mold 4A (see FIGS. 5A and 5B) according to the second embodiment will be described by reference numerals that combine the same numbers and letters.

### <Mold>

The mold 4B according to the third embodiment includes a fixed side mold 24B shown in FIG. 7A and a rotary mold 25B shown in FIG. 7B. FIG. 7A is a back view of the fixed side mold 24B as viewed from a side opposite to the parting line, that is, from a back surface side. The fixed side mold 24B has a circular shape, and includes first and second fixed side recessed portions 40B and 40b, first and second fixed side protruding portions 41B and 41b, and two spaces 55 and 55. The first and second fixed side recessed portions 40B and 40b, the first and second fixed side protruding portions 41B and 41b, and the two spaces 55 and 55 are arranged at equal intervals at an interval of 60 degrees when viewed from the center of the circle.

FIG. 7A shows the rotary mold 25B as viewed from the parting line. The rotary mold 25B has a circular shape similarly to the fixed side mold 24B. The rotary mold 25B is adapted to slide rotationally around the center of the circle. That is, the mold is a slide mold that slides rotationally. The rotary mold 25B is formed with first and second core storage holes 27B and 27b. First and second slide cores 28B and 28b are stored in the first and second core storage holes 27B and 27b, respectively, thereby forming first and second slide side recessed portions 30B and 30b, respectively. In the rotary mold 25B, first and second slide side protruding portions 31B and 31b and two spaces 55, 55 are formed. The first and second slide side recessed portions 30B and 30b, the first and second slide side protruding portions 31B and 31b, and the two spaces 55 and 55 are arranged at equal intervals at an interval of 60 degrees when viewed from the center of the circle.

### <Operation of Mold>

When the rotary mold 25B is set to a rotation position shown in FIG. 7B and clamped to the fixed side mold 24B, the first slide side recessed portion 30B and the first fixed side protruding portion 41B form one primary molding cavity, and the first fixed side recessed portion 40B and the first slide side protruding portion 31B form one primary molding cavity. That is, a total of two primary molding cavities are formed. Then, the second slide side recessed portion 30b and the second fixed side recessed portion 40b form one secondary molding cavity. When resin is injected into the two primary molding cavities in the injection molding step S1 (see FIG. 4), two primary molded articles are obtained.

As described above, it is also preferable that the one mold half is rotationally slid with respect to the other mold half, and the mold may be clamped at two or more mold clamping positions having the first and second mold clamping positions, depending on the rotation position.

The mold 4B is opened, and the rotary mold 25B is rotated 120 degrees as shown in FIG. 7C. When the mold 4B is clamped at this rotation position, the first slide side recessed portion 30B and the first fixed side recessed portion 40B form a secondary molding cavity. Meanwhile, the second slide side recessed portion 30b and the second fixed side protruding portion 41b form one primary molding cavity, and the second fixed side recessed portion 40b and the second slide side protruding portion 31b form one primary molding cavity. That is, a total of two primary molding cavities are formed. By performing the press-fusion step S5 (see FIG. 4) in the secondary molding cavity and simultaneously performing the injection molding step S1 of injecting resin into the two primary molding cavities, a molded article and a pair of primary molded articles can be simultaneously molded.

### Fourth Embodiment

### <Injection Molding Machine System>

An injection molding machine system 1C according to a fourth embodiment is shown in FIG. 8. The injection molding machine system 1C according to the fourth embodiment includes a so-called double-head injection molding machine 2C, two heater devices 3 and 3, two sets of molds 4 and 4, and pressing means 6 and 6 provided on the two sets of molds 4 and 4.

### <Injection Molding Machine>

The injection molding machine 2C according to the fourth embodiment includes a mold clamping device 7C and two injection devices 9C and 9c provided on the bed BD. The mold clamping device 7C includes three mold platens. That is, the mold clamping device 7C includes the fixed platen 12 that is fixed to the bed BD, a movable platen 58 that is slidable on the bed BD, and an intermediate platen 59 that is provided between the fixed platen 12C and the movable platen 58 and is slidable on the bed BD. When a mold clamping mechanism (not shown) is driven, the fixed platen 12, the intermediate platen 59, and the movable platen 58 are clamped together. One of the two injection devices 9C and 9c is provided on the fixed platen 12, and the other is provided on the movable platen 58, and resin is injected from both of the two injection devices 9C and 9c.

### <Mold>

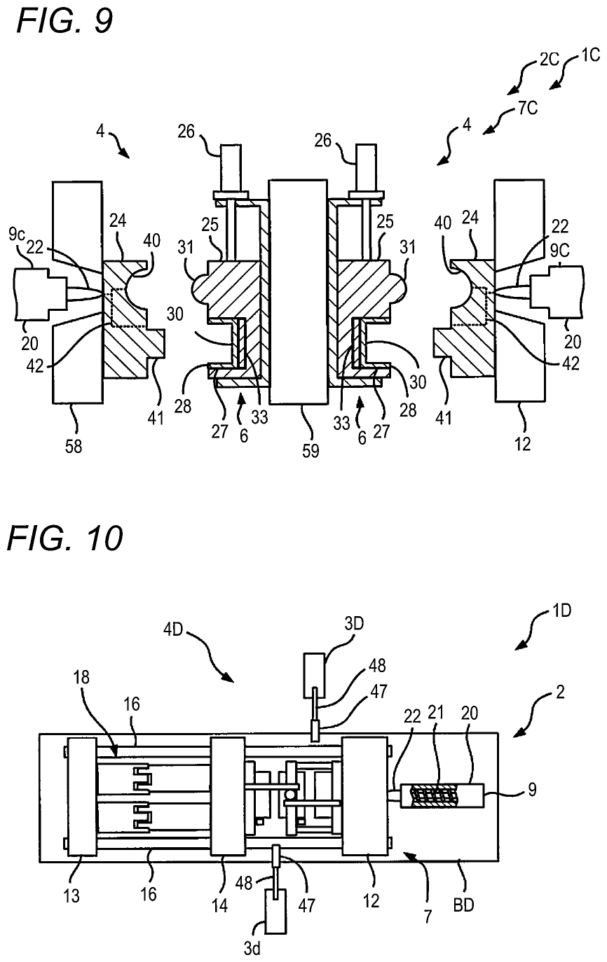

In the injection molding machine 2C according to the fourth embodiment, as shown in FIGS. 8 and 9, one set of the molds 4 is provided between the fixed platen 12 and the intermediate platen 59, and one set of the molds 4 is provided between the movable platen 58 and the intermediate platen 59. Since the two sets of molds 4 are the same as the mold 4 described in the first embodiment, description thereof will be omitted.

In the fourth embodiment, two sets of molds 4 and 4 are provided, and when the mold clamping device 7C is used for clamping, clamping forces can be applied simultaneously, which is efficient. Further, injection molding can be performed by two injection devices 9C and 9c, and two heater devices 3 and 3 are provided, so that a molded article can be efficiently molded.

Accordingly, the injection molding machine may include three or more mold platens to be clamped together, and any two adjacent mold platens may each be provided with a mold.

### Fifth Embodiment

### <Injection Molding Machine System>

FIG. 10 shows an injection molding machine system 1D according to a fifth embodiment. The injection molding machine 2 of the injection molding machine system 1D has the same configuration as the injection molding machine 2 in the first embodiment. A mold 4D provided in the injection molding machine 2 is a so-called stack mold. The injection molding machine system 1D according to the fifth embodiment includes two heater devices 3D and 3d.

### <Mold>

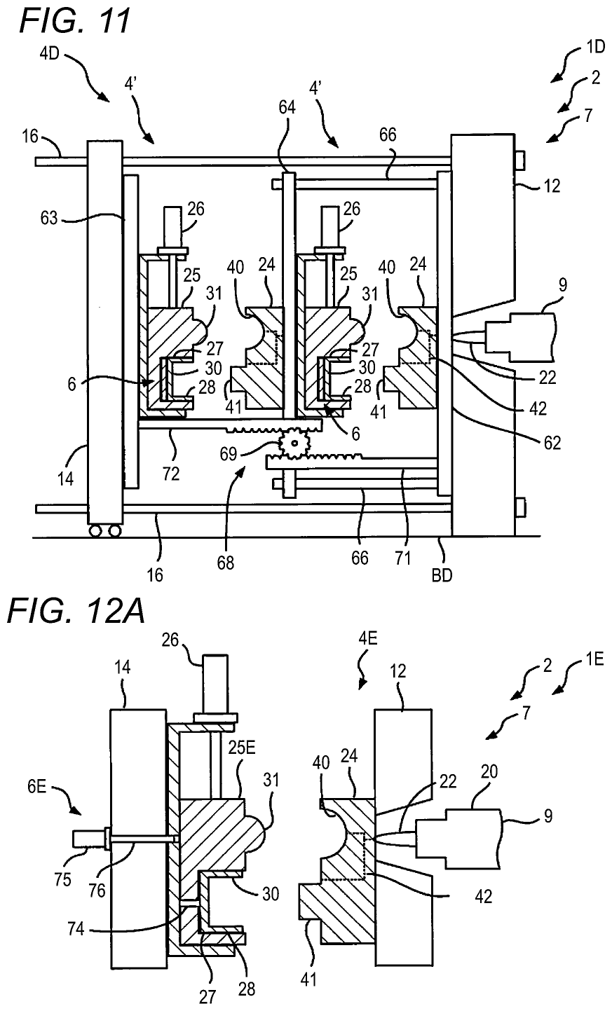

A mold 4D according to the fifth embodiment is shown in FIG. 11. The mold 4D includes a fixed side attachment plate 62 attached to the fixed platen 12, a movable side attachment plate 63 attached to the movable platen 14, and an intermediate plate 64. The mold 4D in the fifth embodiment has a structure including two sets of molds 4′ and 4′ which are substantially the same as the mold 4 described in the first embodiment in FIG. 2. That is, the mold 4′ as a first set is provided between the fixed side attachment plate 62 and the intermediate plate 64, the fixed side mold 24 is attached to the fixed side attachment plate 62, and the slide mold 25 is attached to the intermediate plate 64. The mold 4′ as a second set is provided between the intermediate plate 64 and the movable side attachment plate 63, the fixed side mold 24 is provided on the intermediate plate 64, and the slide mold 25 is provided on the movable side attachment plate 63.

The fixed side attachment plate 62 is provided with a plurality of guide rods 66 and 66, and the intermediate plate 64 is provided so as to be slidable by the guide rods 66 and 66. That is, the intermediate plate 64 slides in directions toward and away from the fixed side attachment plate 62.

The mold 4D includes a rack-pinion mechanism 68. The rack-pinion mechanism 68 includes a pinion 69 rotatably provided on the intermediate plate 64, a first rack 71 fixed to the fixed side attachment plate 62, and a second rack 72 fixed to the movable side attachment plate 63. The first rack 71 and second rack 72 are engaged with the pinion 69. Accordingly, as the movable platen 14 is driven and the movable side attachment plate 63 slides, the intermediate plate 64 slides in conjunction. That is, the two sets of molds 4′ and 4′ are simultaneously opened and closed. Accordingly, in the fifth embodiment, a molded article can be efficiently molded as in the fourth embodiment.

As described above, the mold is a stack mold that is clamped at parting lines on a plurality of surfaces, and one mold half and the other mold half may be provided in each of the parting lines on the plurality of surfaces which are joined when the mold is clamped.

### Sixth Embodiment

### <Injection Molding Machine System>

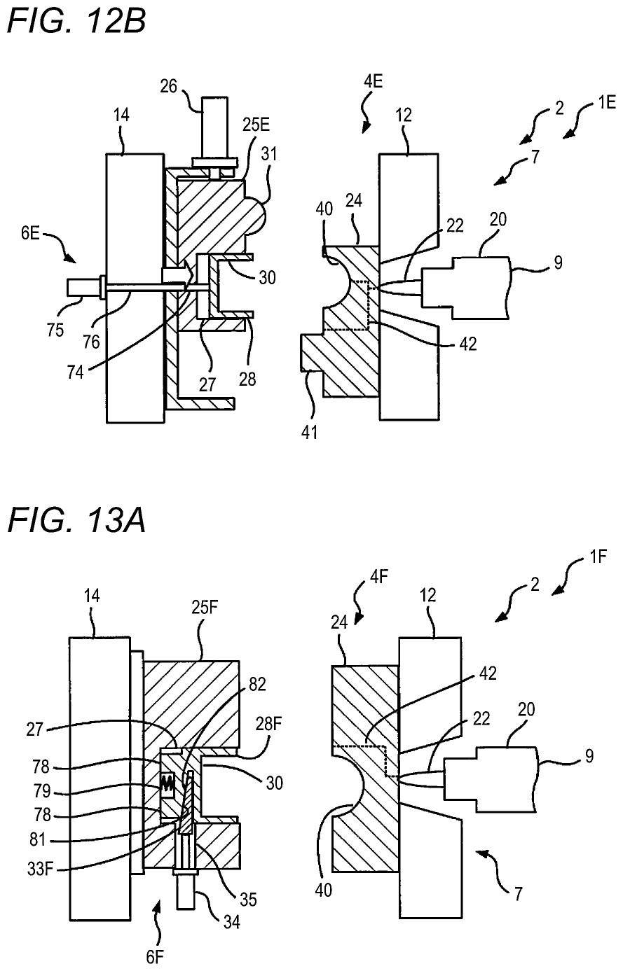

A part of an injection molding machine system 1E according to a sixth embodiment is shown in FIG. 12A. The configuration of the injection molding machine system 1E according to the sixth embodiment is different from the configuration of the injection molding machine system 1 (see FIGS. 1 and 2) according to the first embodiment in that a mold 4E is partially modified and pressing means 6E is modified. In the mold 4E, a rod hole 74 is opened in a bottom surface of the core storage hole 27 in a slide mold 25E. The pressing means 6E includes a hydraulic cylinder 75 provided on the movable platen 14, and a piston rod 76 thereof passes through the movable platen 14.

As shown in FIG. 12A, when the slide mold 25E is at the first mold clamping position, the slide core 28 is in contact with the bottom surface of the core storage hole 27. When the mold is clamped in this state and the injection molding step S1 (see FIG. 4) is performed, the injection pressure acting on the slide core 28 can be received by the bottom surface of the core storage hole 27. When the cylinder unit 26 is driven to move the slide mold 25E to the second mold clamping position, the rod hole 74 is aligned with the piston rod 76 as shown in FIG. 12B. When the piston rod 76 is driven by the hydraulic cylinder 75, the slide core 30 can be driven. Accordingly, the press-fusion step S5 (FIG. 4) can be performed.

### Seventh Embodiment

### <Injection Molding Machine System>

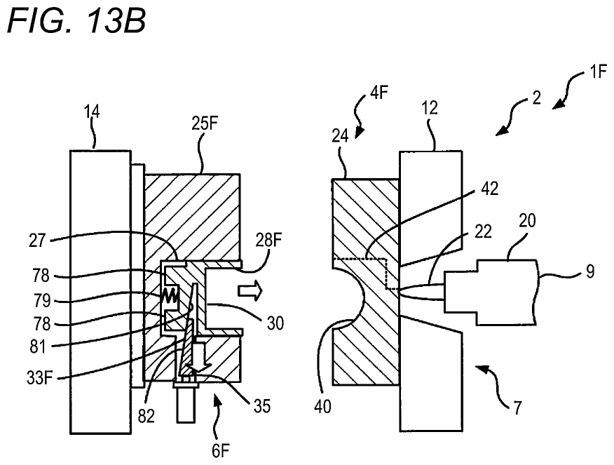

A part of an injection molding machine system 1F according to a seventh embodiment is shown in FIG. 13A. The configuration of the injection molding machine system 1F according to the seventh embodiment is different from the configuration of the injection molding machine system 1 (see FIGS. 1 and 2) according to the first embodiment in that pressing means 6F is modified, and accordingly, a slide mold 25F of a mold 4F is also modified. Legs 78 and 78 are formed on a slide core 28F serving as the pressing means 6F, and are in contact with the bottom surface of the core storage hole 27. A spring 79 is provided between the slide core 28F and the core storage hole 27 to bias the slide core 28F in the direction of the parting line. A hole having a tapered surface 81 is formed on the slide core 28F, and a slide member 33F having a tapered surface 82 is inserted into the hole.

When the hydraulic cylinder 34 of the pressing means 6F is driven to push the slide member 33F, a state shown in FIG. 13A is reached. At this time, the legs 78, 78 of the slide core 28F are in contact with the bottom surface of the core storage hole 27. Therefore, when the injection molding step S1 (see FIG. 4) is performed, the slide core 28F can withstand the injection pressure. Further, when the hydraulic cylinder 34 is driven to retract the slide member 33F, as shown in FIG. 13B, the slide core 28F is driven in the direction of the parting line by the action of the tapered surfaces 81 and 82 and the biasing of the spring 79. Accordingly, the press-fusion step S5 (see FIG. 4) can be performed.

### <Other Modifications>

The injection molding machine systems 1, 1A, . . . and the molding method for a molded article according to the first to seventh embodiments can be variously modified. For example, in the injection molding machine system 1A (see FIGS. 5A and 5B) according to the second embodiment, the mold 4A may be modified, and three or more slide cores 28A and 28a may be provided to form three or more slide side recessed portions 30A and 30a. At this time, three or more slide side protruding portions 31A and 31a are provided, two or more fixed side protruding portions 41 are provided, and three or more fixed side recessed portions 40A and 40a are provided. Therefore, two or more molded articles can be simultaneously molded in one molding cycle.

Further, for example, in the injection molding machine system 1C (see FIGS. 8 and 9) according to the fourth embodiment, four or more mold platens that are clamped together may be provided, and three or more sets of molds 4, 4, . . . that are clamped simultaneously may be provided. Similarly, in the injection molding machine system 1D (see FIGS. 10 and 11) according to the fifth embodiment, the mold 4D implemented by a stack mold may be modified, and three or more sets of molds 4′, 4′, . . . may be provided. In either modification, the number of molded articles that can be molded in one molding cycle can be increased.

In the second embodiment (see FIG. 5A), the fourth embodiment (see FIG. 8), and the fifth embodiment (see FIG. 10), two slide side recessed portions 30A, 30, . . . are provided, and two fixed side recessed portions 40A, 40, . . . are also provided. The recessed portions do not necessarily have to be the same shape. That is, two different types of molded articles may be molded by changing the shape.

The pressing means 6 may also be modified. For example, in the injection molding machine system 1E (see FIG. 12A) according to the sixth embodiment, the pressing means 6E is implemented by the hydraulic cylinder 75, and the slide core 28 is driven by the piston rod 76. The pressing means 6E may be implemented by an ejector rod of an ejector device. That is, the slide core 28 is driven by the ejector rod. That is, the pressing means may be an ejector rod, and the slide core may be driven by the ejector rod.

The rack-pinion mechanism 68 in the fifth embodiment (see FIG. 11) may also be modified. That is, the rack-pinion mechanism 68 may be replaced by another mechanism having the same function. As an example of alternative means, a link mechanism may be adopted.

The heating means may also be modified. It has been described that the heating means includes the heater 47 which performs heating with infrared rays in a non-contact manner. Alternatively, the heating means may include a heater made of a heated metal plate or the like, and perform heating by contact. In this case, the heater is brought into contact with the bonding end surfaces 50s and 51s of the first and second primary molded articles 50 and 51 (see FIG. 3D) for direct melting.

The molding method may also be modified. In the molding method according to the first embodiment, the melting step S3 is described as being performed by setting the slide mold 25 to the second mold clamping position. However, when the melting step S3 is performed, the slide mold 25 may be set at the first mold clamping position. The slide mold 25 may be set to the second mold clamping position during the mold closing step S4.

Although the invention made by the present inventor has been specifically described above based on the embodiments, it is needless to say that the present invention is not limited to the embodiments described above, and various modifications can be made without departing from the scope of the invention. The plurality of examples described above may be appropriately combined.

### INDUSTRIAL APPLICABILITY

According to the present disclosure, it is possible to provide an injection molding machine system, a mold, and a molding method for a molded article that can reliably fuse a pair of primary molded articles together to obtain a molded article, while minimizing the risk of damaging a mold.

Although the present invention has been described in detail with reference to specific embodiments, it will be apparent to those skilled in the art that various changes and modifications can be made without departing from the spirit and scope of the present invention.

The present application is based on Japanese Patent Application No. 2022-001282 filed on Jan. 6, 2022, and the contents thereof are incorporated herein as reference.

REFERENCE SIGNS LIST

| | | | |
|---|---|---|---|
| 1, 1A, 1C, 1D, 1E, 1F | Injection molding machine system | | |
| 2, 2C | Injection molding machine | | |
| 3, 3D, 3d | Heater device | | |
| 4, 4A, 4B, 4D, 4′, 4E, 4F | Mold | | |
| 6, 6A, 6a, 6E, 6F | Pressing means | | |
| 7, 7C | Mold clamping device | | |
| 9, 9C, 9c | Injection device | | |
| 12 | Fixed platen | 13 | Mold clamping housing |
| 14 | Movable platen | 16 | Tie bar |
| 18 | Toggle mechanism | 20 | Heating cylinder |
| 21 | Screw | 22 | Injection nozzle |
| 24, 24A, 24B | Fixed side mold | | |
| 25, 25A, 25B, 25E, 25F | Slide mold | | |
| 26 | Cylinder unit | | |
| 27, 27A, 27a, 27B, 27b | Core storage hole | | |
| 28, 28A, 28a, 28B, 28b, 28F | Slide core | | |
| 30, 30A, 30a, 30B, 30b | Slide side recessed portion | | |
| 31, 31A, 31a, 31B, 31b | Slide side protruding portion | | |
| 33, 33A, 33a, 33F | Slide member | | |
| 34 | Hydraulic cylinder | 35 | Hole |
| 37 | Tapered surface | 38 | Tapered surface |
| 40, 40A, 40a, 40B, 40b | Fixed side recessed portion | | |
| 41, 41B, 41b | Fixed side protruding portion | | |
| 42 | Runner | 47 | Heater |
| 48 | Drive unit | | |
| 50, 50A | First primary molded article | | |
| 51, 51A | Second primary molded article | | |
| 50s, 50As | Bonding end surface | | |
| 51s, 51As | Bonding end surface | | |
| 53, 53A | Molded article | | |
| 55 | Space | | |
| 58 | Movable platen | 59 | Intermediate platen |
| 62 | Fixed side attachment plate | 63 | Movable side attachment plate |
| 64 | Intermediate plate | 66 | Guide rod |
| 68 | Rack-pinion mechanism | 69 | Pinion |
| 71 | First rack | 72 | Second rack |
| 74 | Rod hole | 75 | Hydraulic cylinder |
| 76 | Piston rod | 78 | Leg |
| 79 | Spring | | |
| 81 | Tapered surface | 82 | Tapered surface |
| BD | Bed | | |

1. An injection molding machine system comprising:
an injection molding machine;
a mold provided in the injection molding machine;
a heater device; and
a pressing device,
wherein the mold is configured such that one mold half is slidable relative to the other mold half and is configured to clamp at two or more mold clamping positions including a first mold clamping position and a second mold clamping position,
wherein the one mold half has at least one one-side recessed portion in which the pressing device is provided, and the other mold half has at least one other-side recessed portion,
wherein when the mold is clamped in the first mold clamping position, at least one primary molding cavity is formed by the one-side recessed portion, and at least one primary molding cavity is formed by the other-side recessed portion,
wherein when the mold is closed or clamped in the second mold clamping position, a secondary molding cavity is formed by the one-side recessed portion and the other-side recessed portion,
wherein the primary molding cavity is configured to mold a primary molded article having a bonding end surface by injection molding,
wherein the heater device is configured to melt the bonding end surface of the primary molded article placed in the one-side recessed portion and the bonding end surface of the primary molded article placed in the other-side recessed portion, and
wherein the pressing device is configured to press, in the secondary molding cavity, the primary molded article having the molten bonding end surface and placed in the one-side recessed portion to fuse with the primary molded article having the molten bonding end surface and placed in the other-side recessed portion.

2. The injection molding machine system according to claim 1, wherein the heater device includes a heater configured to emit an infrared ray to melt the bonding end surface in a non-contact manner.

3. The injection molding machine system according to claim 1, wherein the one mold half is linearly slidable with respect to the other mold half, and the mold is clamped at two or more mold clamping positions including the first mold clamping position and the second mold clamping position, depending on a sliding position.

4. The injection molding machine system according to claim 1, wherein the one mold half is rotationally slidable with respect to the other mold half, and the mold is clamped at two or more mold clamping positions including the first mold clamping position and the second mold clamping position, depending on a rotation position.

5. The injection molding machine system according to claim 1,
wherein the one-side recessed portion is formed in a slide core stored in a core storage hole opened in the one mold half, and
wherein the slide core is configured to be driven by the pressing device in a direction perpendicular to a parting line of the mold.

6. The injection molding machine system according to claim 5,
wherein the pressing device includes a slide member configured to slide parallel to the parting line of the mold, and
wherein a back surface of the slide core and a front surface of the slide member are respectively formed into tapered surfaces, and the tapered surfaces allow for sliding contact with each other.

7. The injection molding machine system according to claim 5,
wherein the pressing device is an ejector rod, and
wherein the slide core is configured to be driven by the ejector rod.

8. The injection molding machine system according to claim 1,
wherein the injection molding machine includes three or more mold platens to be clamped together, and
wherein any two adjacent mold platens are each provided with the mold.

9. The injection molding machine system according to claim 1,
wherein the mold is a stack mold that is clamped at parting lines on a plurality of surfaces, and
wherein the one mold half and the other mold half are provided in each of the parting lines on the plurality of surfaces which are joined when the mold is clamped.

10. The injection molding machine system according to claim 1, further comprising:
a control device,
wherein the control device is configured to perform:
an injection molding step comprising sliding the one mold half relatively to the other mold half to clamp the mold at the first mold clamping position and injecting resin into the primary molding cavities to form two or more primary molded articles;
a melting step comprising opening the mold and melting the bonding end surface of the primary molded article remaining in the one-side recessed portion and the bonding end surface of the primary molded article remaining in the other-side recessed portion by the heater device;
a mold closing step comprising sliding the one mold half relative to the other mold half and closing or clamping the mold at the second mold clamping position to form the secondary molding cavity; and
a press-fusion step comprising pressing a pair of the primary molded articles placed in the secondary molding cavity by the pressing device to fuse the bonding end surfaces together, resulting in a molded article.

11. The injection molding machine system according to claim 10, wherein the control device is configured to perform the press-fusion step and the injection molding step in parallel and substantially simultaneously, and in the case of obtaining the molded article from the pair of primary molded articles by performing the press-fusion step, mold another pair of primary molded articles by performing the injection molding step.

12. A mold comprising one mold half, which is a first mold half, and another mold half, which is a second mold half,
wherein the first mold half is slidable relative to the second mold half such that the mold is clamped at two or more mold clamping positions including a first mold clamping position and a second mold clamping position,
wherein the first mold half has at least one one-side recessed portion in which a pressing device is provided, and the second mold half has at least one other-side recessed portion,
wherein when the first mold half and the second mold half are clamped in the first mold clamping position, at least one primary molding cavity is formed by the one-side recessed portion, and at least one primary molding cavity is formed by the other-side recessed portion,
wherein when the first mold half and the second mold half are clamped in the second mold clamping position, a secondary molding cavity is formed by the one-side recessed portion and the other-side recessed portion,
wherein the primary molding cavity is for molding a primary molded article having a bonding end surface by injection molding, and
wherein the pressing device is configured to press, in the secondary molding cavity, the primary molded article placed in the one-side recessed portion against the primary molded article placed in the other-side recessed portion.

13. A molding method for molding a molded article in an injection molding machine system,
the injection molding machine system including:
an injection molding machine;
a mold provided in the injection molding machine;
a heater device; and
a pressing device,
the mold being configured such that one mold half is slidable relative to the other mold half and is configured to clamp at two or more mold clamping positions including a first mold clamping position and a second mold clamping position,
the one mold half having at least one one-side recessed portion in which the pressing device is provided, and the other mold half having at least one other-side recessed portion,
when the mold is clamped in the first mold clamping position, at least one primary molding cavity being formed by the one-side recessed portion, and at least one primary molding cavity being formed by the other-side recessed portion, and
when the mold is clamped in the second mold clamping position, a secondary molding cavity being formed by the one-side recessed portion and the other-side recessed portion,
the molding method comprising:
an injection molding step comprising molding two or more primary molded articles each having a bonding end surface by clamping the mold in the first mold clamping position and injecting resin into the two or more primary molding cavities;
a mold opening step comprising opening the mold, leaving at least one of the primary molded articles in the one-side recessed portion and one of the primary molded articles in the other-side recessed portion;
a melting step of melting the bonding end surfaces of the two or more primary molded articles by the heater device;
a mold closing step comprising retracting the heating device, and closing or clamping the mold at the second mold clamping position to align the one primary molded article placed in the one-side recessed portion and the primary molded article placed in the other-side recessed portion in the secondary molding cavity; and
a press-fusion step comprising pressing the primary molded article placed in the one-side recessed portion against the primary molded article placed in the other-side recessed portion by the pressing device to fuse the bonding end surfaces of the primary molded articles together, resulting in the molded article.
